(19) United States
(12) Patent Application Publication
(10) Pub. No.: US 2019/0264973 A1
(43) Pub. Date: Aug. 29, 2019

(54) ZONE ISOLATION CONTROL SYSTEM FOR TRANSPORT REFRIGERATION UNITS

(71) Applicant: Ronald Koelsch, Roscommon, MI (US)

(72) Inventor: Ronald Koelsch, Roscommon, MI (US)

(21) Appl. No.: 15/904,621

(22) Filed: Feb. 26, 2018

(51) Int. Cl. F25D 11/00; F25D 11/02; F25B 21/02; F25B 40/02; F25B 31/02; F25D 17/06; F25D 16/00

(52) U.S. Cl. CPC F25D 11/003; F25D 11/022; F25B 21/02; F25B 40/02; F25B 31/02; H02S 99/00; F25D 16/00; F25D 2400/02; F25D 2600/02; F25B 2500/28; F25D 2700/02; F25D 17/06

(57) ABSTRACT

Multi-zone transport refrigeration units (TRUs). A combination of temperature controlled flow of cold air and time controlled refrigerant distribution is used to improve cooling performance and reduce power consumption. This dual-control zone isolation system makes it possible to use solar panels to power the TRU.

This application is a utility application claiming priority from U.S. Utility patent application Ser. No. 15/283,710, filed Oct. 3, 2016 which claims priority from U.S. Provisional patent application Ser. No. 62/245,366, filed Oct. 23, 2015.

The instant invention relates to the efficiency of multi-zone transport refrigeration units (TRUs).

### BACKGROUND OF THE INVENTION

The instant invention relates to the mode of operation, efficiency, and energy impact of multi-zone transport refrigeration units (TRUs). Typical multi-zone TRUs existing in the field have a layout containing multiple temperature zones. Zone 1 (Z1) typically includes a freezer; Zone 2 (Z2) is typically a refrigerated compartment; Zone 3 (Z3) is typically a second refrigerator or an ambient temperature chamber for dry goods.

Prior art TRUs regulate the temperature of Z2 and Z3 by sourcing refrigerant from Z1 and supplying the refrigerant to adjacent temperature zones, Z2 and Z3. Refrigerant is moved through the system via a 60-foot flow loop connecting the freezer refrigerant source in Z1 to remote evaporators in Z2 and Z3. This configuration is problematic because Z1 freezer temperatures are compromised by the consequent refrigerant transfer required when Z2 and/or Z3 operate in high demand mode.

Z1 host freezer evaporators typically run at a temperature of −20° F. to 0° F. Due to the refrigerant transfer required when the Z2 and Z3 remote evaporators require cooling, freezer temperatures rise and critical freezer set points cannot be reached without high duty cycle times. The prior art does not adequately compensate for the freezer performance loss associated with refrigerant transfer.

Prior art TRUs also use hot refrigerant gas from remote evaporators to provide heated air to refrigerator chambers to keep refrigerated food from freezing when the outside ambient air temperature is below freezing, or to defrost evaporators. This is problematic because defrosting the evaporators with hot refrigerant gas causes cooling chamber temperatures to rise and increases the duty cycle.

Present state of the art TRUs are typically powered by diesel engines that power the compressor, fans and remote evaporators. Under this configuration, a small 12-volt battery is used only to power the TRU control computer.

These prior art systems pose energy efficiency and emissions obstacles in the TRU field. Present diesel driven systems typically require 18 Kw (24 horse power) to make 18 Kw of cooling power @ 35° F. using a 50% duty cycle. In one hour, they typically use 9 Kwh of energy. Diesel TRUs emit 50 tons of greenhouse gas (GHG) annually along with nitrogen oxides, reactive organic gasses and particulate matter containing poisonous black carbon.

Prior art has been unable to achieve the efficiency required to operate a semi-trailer sized TRU without reliance on fossil fuel, and no prior art has been able to meet a zero emissions standard.

Prior art TRUs have attempted to improve TRU energy efficiency and emissions through the use of a battery powering electric motors as component parts and the integration of solar panels, however, these TRUs suffer from short run times that limit their usefulness for food delivery logistics. Run times are determined by the total energy stored in the battery versus the energy consumption of the refrigeration unit.

Prior art battery powered TRUs typically use approximately 8 Kw of power, and rely on refrigerant transfer. They use ac power company grid electricity to charge the battery and run the TRU when it is stationary. The prior art has been unable to achieve sustainable symbiosis between the energy demands of the TRU and the output produced by non-diesel energy sources.

Prior art using remote evaporators and timers have done so in combination with conventional refrigerant transfer systems, treating temperature fluctuations as a component of the refrigerant transfer loop. Prior art does not adequately compensate for the energy stress placed on the system by the transfer of refrigerant to remote evaporators. Prior art battery operated transfer refrigeration units without zone control are known from U.S. Pat. No. 8,935,933.

### BRIEF DESCRIPTION OF THE DRAWINGS

FIG. 1 is a full upper side view in perspective of a semi-trailer TRU showing predetermined zones.

FIG. 2 is a full lower side view in perspective of the inside of the TRU of FIG. 1.

FIG. 3 is an illustration showing cold air being routed from the freezer to the refrigerator.

FIG. 4 is a full front view of a refrigeration unit.

FIG. 5 is a full rear view of the TRU of FIG. 1 showing the rectangular airflow ducting recessed into the ceiling of a refrigeration chamber.

FIG. 6A is a full front view in of an evaporator box showing airflow through the evaporator and mixing chamber.

FIG. 6B is a cross sectional view through line 6B-6B of FIG. 6A.

FIG. 7 is a schematic showing the DC micro-grid with solar panel equipped TRUs ganged together.

FIG. 8 is a view in perspective of a thermoelectric cold plate.

### BRIEF SUMMARY OF THE INVENTION

The instant invention creates a cold air delivery system new to the art, which significantly reduces energy expenditure by using airflow as an alternative to refrigerant transfer. Using a combination of battery power, solar power, and airflow control facilitated by fans, ducts, gates, and air temperature controllers, energy is reduced to a critical point whereby alternative energy sources can power the TRU for run-times previously unachievable in the art.

Thus what is disclosed herein is a high efficiency battery powered TRU with zone isolation comprising a refrigeration system wherein timer controls are used to limit refrigerant flow from a freezer zone to remote evaporators. The remote evaporators are located in refrigeration zones other than a host freezer zone and there is a refrigeration air handling system wherein air is extracted directly from a post evaporator cold-air chamber of the host freezer zone. The extracted air is distributed to each of the refrigeration zones to control a single zone temperature, or multiple temperatures in multiple zones, by airflow control using a combination of fans, ducts, gates and air temperature controllers.

The instant invention capitalizes on this energy efficiency by powering the entire refrigeration and airflow system with a solar and battery combination that does not rely on diesel power. Moreover, battery longevity is achieved by using solar panels that may be linked to charge batteries in a micro-grid format and by employing wheel generators as a back-up power source.

The integrated system optimizes energy and eliminates emissions. The advantages of this all-electric TRU over the diesel TRU can be summarized in the table below.

| | Power | cool.Power | Duty Cycle | Run Ener. | Solar Ener. | Emiss. |
|---|---|---|---|---|---|---|
| | Watts | Watts/35° F. | Percent | Watt hrs. | Watt hrs | TonGHG |
| Diesel | 18000 | 18000 | 50 | 9000 | 0 | 50/yr. |
| Electric | 8000 | 18000 | 25 | 2000 | 2000+ | 0 |

The instant air delivery system does not rely on refrigerant transfer to cool refrigeration chambers, but instead uses a zone isolation control system that extracts air directly from a post-evaporator cold air chamber and pulls warm air from the refrigerator chambers. The system brings the extracted warm air forward to the freezer chamber, and then directs it to a mixing chamber isolated from the freezer evaporator.

The warm return air from the refrigerator chamber is mixed with the cold post-freezer evaporator air in the mixing chamber. The cold-mixed air is then directed to flow back to the Z2 or Z3 refrigerator chamber to lower its temperature. Similarly, this airflow system improves performance in single refrigeration chamber TRUs by delivering post-freezer evaporator cold air to the rear of the chamber.

In both instances, the instant design allows faster refrigerator cooling response, improves the performance of the overall refrigeration system, and decreases the refrigeration duty cycle.

The instant airflow system of ducting and pass through openings is sequenced on a temperature control basis to bring cold air from the freezer to the refrigerator as needed. It is delivered to isolated refrigeration zones, Z2 and Z3, to maintain a single temperature or multiple temperatures across multiple zones.

Because refrigerant flow is uncompromised in Z1, the freezer temperature deficiencies suffered by the prior art are eliminated. Consequently, energy is conserved, higher operating efficiency is achieved, and Z1 continuously operates at peak performance levels.

Moreover, the instant invention's zone isolation system eliminates the use of remote evaporators and the high duty cycle problems associated with defrosting the evaporators with hot refrigerant gas. The instant system alternatively uses electric heater rods to quickly provide hot air, when required, to defrost the single freezer evaporator or to maintain above freezing refrigerator temperatures.

The instant airflow system creates a low-duty cycle, so it is not prone to evaporator frosting. However, if defrosting of the Z1 evaporator is required, the electric heater rods can efficiently defrost the unit without causing freezer chamber temperatures to rise. It therefore consumes less energy than the prior art while maintaining better temperature control.

The instant invention further reduces energy consumption and eliminates the fossil fuel emissions produced by the prior art. Unlike prior art TRUs, which draw power from a diesel engine to operate cooling zones, the instant invention powers electric drive and fan motors solely by battery. An electric motor then drives the refrigeration compressor and fans, such that air can be extracted directly from a post-evaporator cold-air mixing chamber located in Z1 for distribution to isolated cooling compartments Z2 and Z3.

The instant invention further solves power sustainability issues proposed by the prior art by connecting the battery to a solar panel embodiment. Unlike the prior art, this invention uses an integrated system that lowers energy expenditure within the TRU to levels that are able to be recaptured by an integrated solar panel. Battery longevity is therefore increased beyond what is achievable under the prior art.

When more than one TRU is equipped with a solar panel, the configuration supports fleet charging. When the solar powered TRUs are parked in a common location, such as a warehouse yard used for loading or staging, they can be plugged into a common power network, thereby ganging them into a direct current micro-grid formation such that TRUs needing charging can draw power from their own solar panel or the solar panels of other fully charged TRUs.

A central energy storage battery can be included in this power arrangement along with land based auxiliary solar panels. Effectively, this configuration allows the fleet of TRUs to become a local solar generation station facilitating operation of TRUs completely off the power company electrical grid commonly called shore power.

The instant invention further eliminates battery sustainability problems by using an optional back-up wheel generator as a reserve electric power source. Adjusting the voltage regulator so the system is purely regenerative eliminates increased semi-tractor fuel consumption and emissions. An accelerometer controls the voltage regulator so power is only generated during deceleration. There is no additional drag on the tractor during acceleration and cruise. The system can be programmed to generate continuous power during an emergency low battery charge condition whenever the speed of motion is above a set minimum speed.

### DETAILED DESCRIPTION OF THE INVENTION

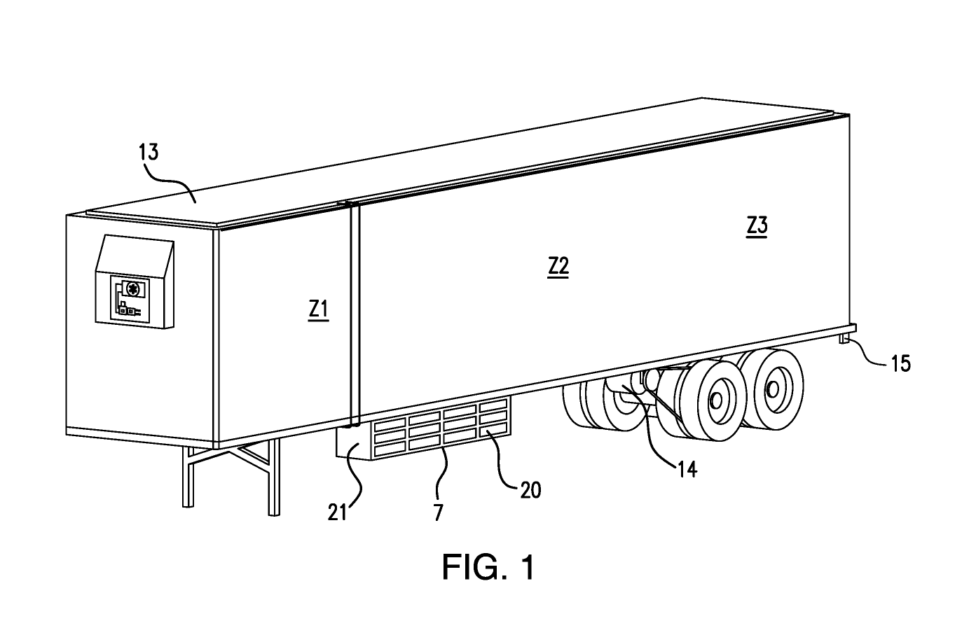

A typical TRU layout of the instant invention is shown in FIG. 1 where zone one (Z1) is a freezer, zone two (Z2) a refrigerator and zone three (Z3) may be a second refrigerator or an ambient temperature chamber for dry goods.

The freezer (Z1) requires the most cooling to hold sub-freezing temperatures. Present art TRUs take refrigerant from the Z1 freezer evaporator and move it to remote evaporators in Z2 and Z3 whenever they demand cooling based on temperature. Z2 and Z3 take priority over Z1 and Z1 and performance suffers putting frozen product at risk. This invention prevents this degradation of freezer performance by totally eliminating the remote evaporators and refrigerant flow loop from the freezer Z1 to remote evaporators in Z2 and Z3.

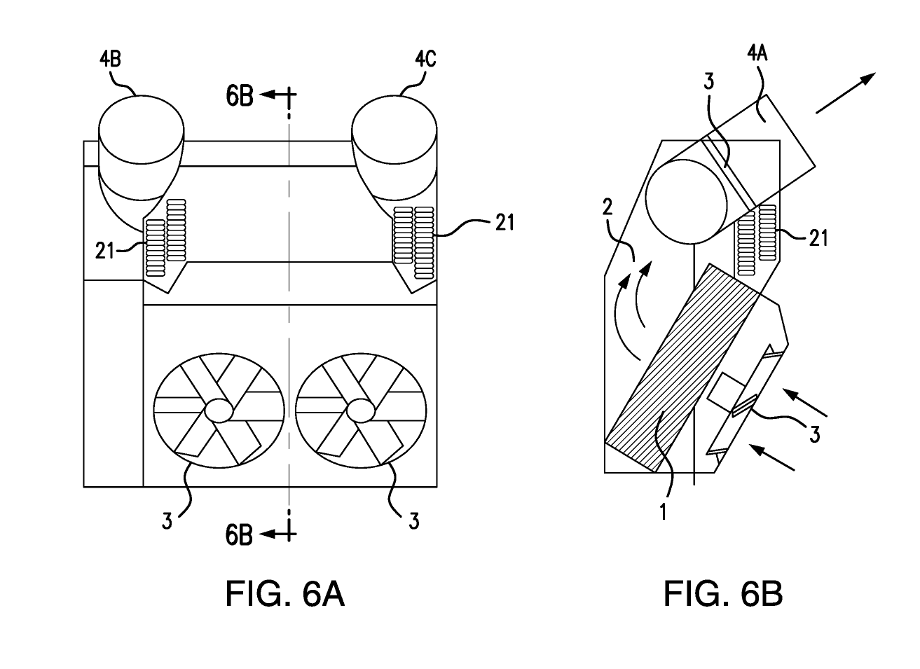

Instead of taking refrigerant from the Z1 evaporator (1) illustrated in FIG. 6, this invention draws cold air from the host-freezer Z1 post evaporator mixing chamber (2), delivers it to the non-host refrigerator chambers Z2 and Z3 to maintain their temperatures.

Each zone is controlled such that Z1 has priority, refrigerant is never removed from the Z1 evaporator, and the critical freezer temperature is strictly maintained. Z1 temperature control is improved and the TRU runs less time giving the refrigeration system a lower duty cycle.

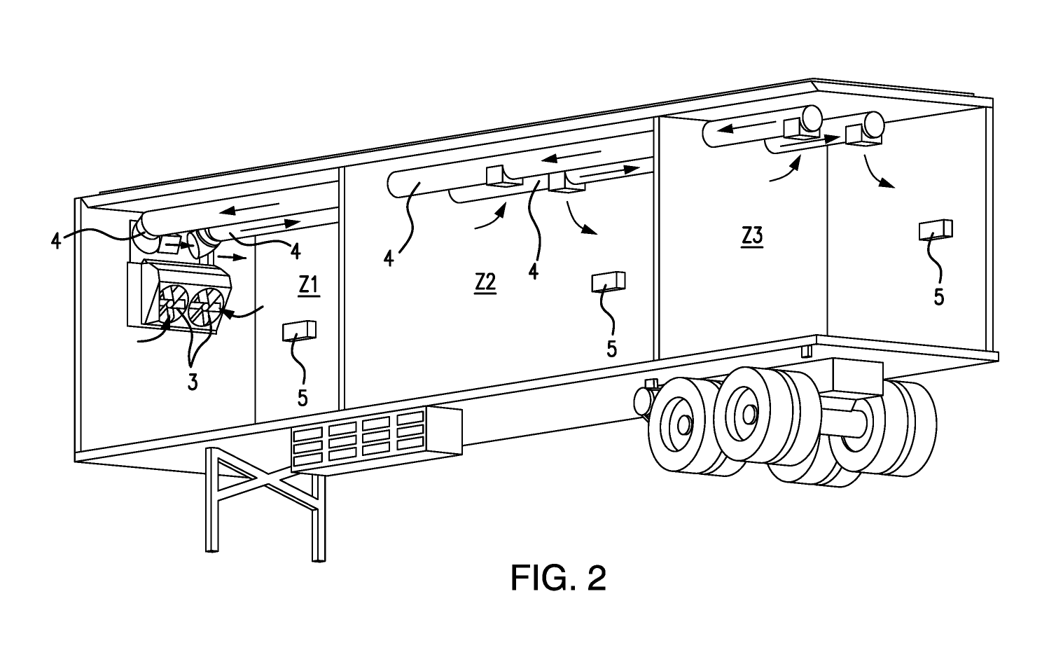

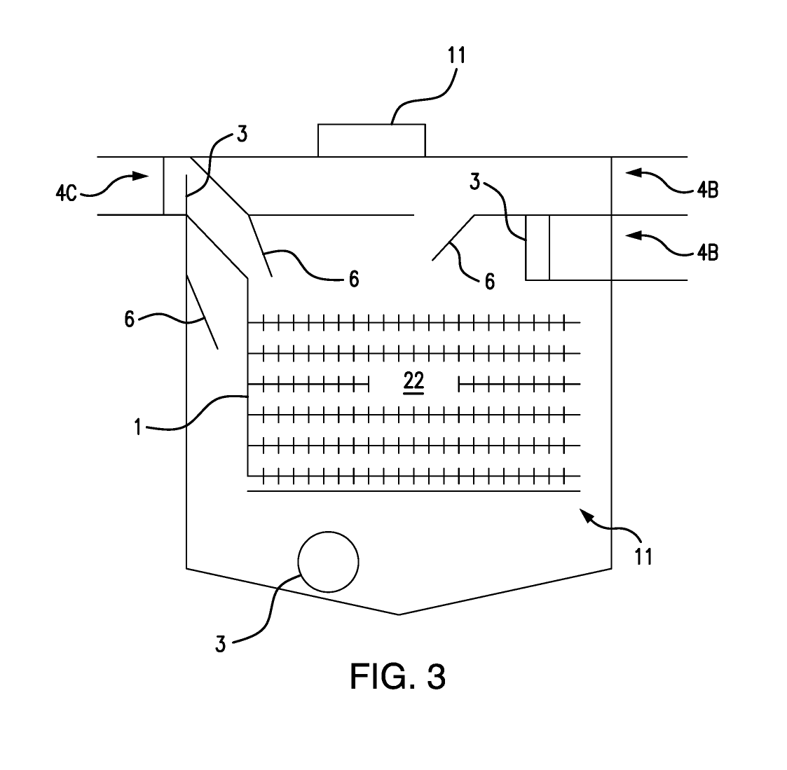

Cold air is routed from the freezer Z1 to the refrigerators Z2 and Z3 using the system of fans (3), ducting (4), temperature sensors (5) and control gates (6) as illustrated in FIG. 2 and FIG. 3. The Location of the mixing gates (6) are shown in FIG. 3. The arrows in FIG. 2 show the direction of airflow. This method of cooling the refrigerator chambers is faster acting and more efficient with a lower duty cycle than pumping refrigerant to remote evaporators in the refrigerators.

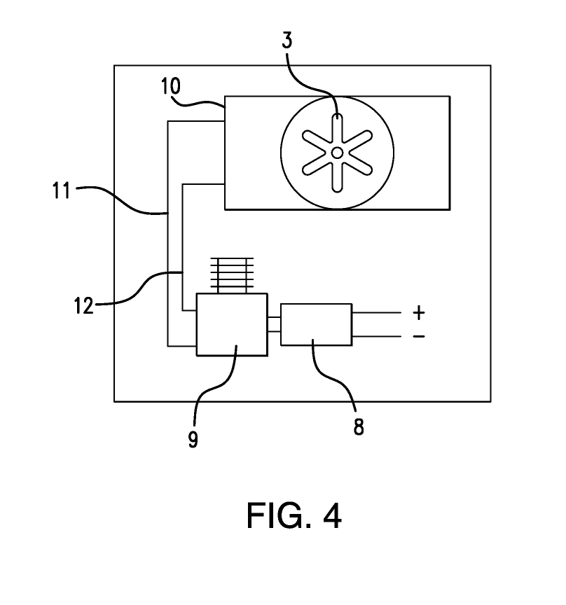

Lower duty cycle means less cooling energy is required to maintain the set point temperatures of the freezer Z1 and refrigerators Z2 and Z3. The 8 Kw power draw on the battery (7) in FIG. 1, by the direct current (dc) electric motor (8) that drives the refrigeration compressor (9) and condenser (10), shown in FIG. 4, and the dc electric motors of the airflow fans (3) only occurs 25% of the time. The electric energy used to run the refrigeration system for one hour is only 2 Kwh because of the low 25% duty cycle achieved by this zone isolation airflow system.

Also shown in FIG. 3, are electric heating elements (11) in the evaporator area that are used to provide refrigerator heating in cold ambient conditions. They are also used to defrost the evaporator (1). This electric defrost adds to the efficiency of the all-electric battery powered TRU. The electric defrost is more efficient and faster acting than current defrost systems that use hot refrigerant gas.

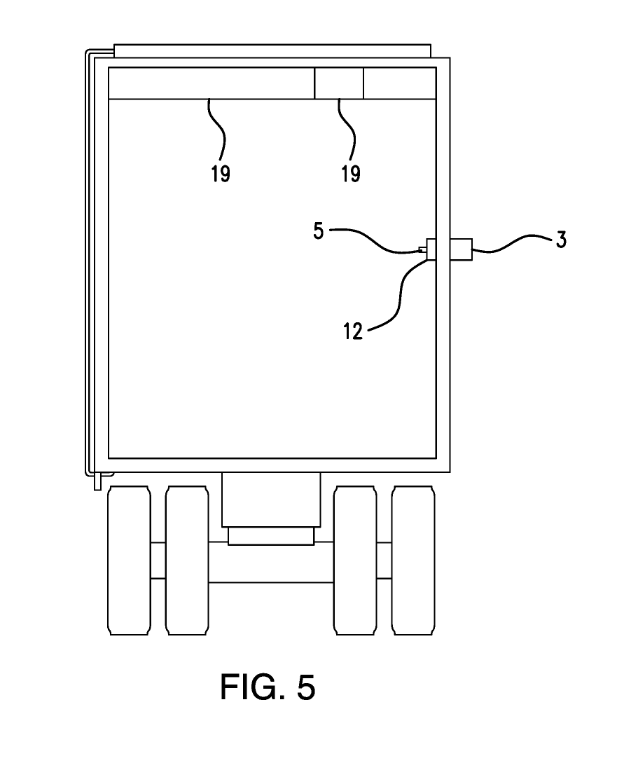

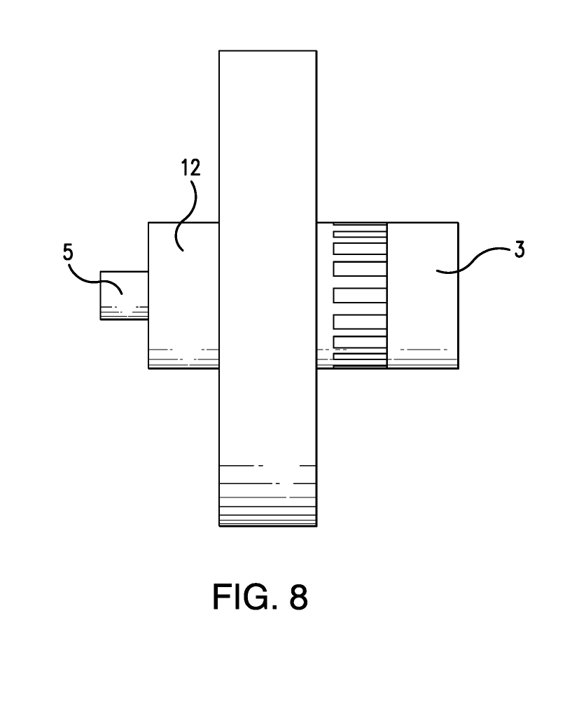

A thermo-electric cooling plate (12) shown in FIG. 8 and FIG. 5, is used to mount the temperature sensors (5). These plates quickly cool the temperature sensors in each zone of an ambient air temperature TRU upon startup to near set point temperature. The cooling plate (12) and electric motor (3) are turned off when the sensor temperature is near set point temperature. This avoids the lag time between fast chamber air cooling and slower sensor cooling. This improves sensor reaction time to big air temperature changes in the refrigeration chambers. Heat is transferred from the refrigeration chambers Z1, Z2 and Z3 to the outside ambient air as shown in FIG. 8 and FIG. 5.

The zone isolation system of the instant invention brings the one hour energy consumption of an 18 Kw at 35° F. cooling capacity battery-powered TRU down from 8 Kwh to 2 Kwh. This makes it possible for the first time to use solar panels (13), shown in FIG. 1, as the sole power source for mobile refrigeration systems such as a TRU.

Semi-trailers have upwards of 400 square feet of roof area available. Present solar panel efficiency will produce 4 Kw or more of solar-electrical power from this area. Storing ten hours of solar panel produced power in the battery (7) of the battery-powered TRU provides 40 Kwh of electrical energy, more than enough energy to run the battery-powered TRU on a typical delivery route. The battery/solar-powered TRU has zero emissions during operation.

A backup wheel generator system (14) is shown in FIG. 1, that only makes power during deceleration in a regenerative fashion, preserving the no emissions feature of this invention. It can be turned on automatically to continuously produce power during emergency low-battery charge situations to run the refrigeration system including the electric motor (8) and fans (3) and charge the battery (7). Likewise an optional charger plug-in socket (15) is shown in FIG. 1 where either an onboard or land based battery charger/apu can be used to charge the battery and run the refrigeration system.

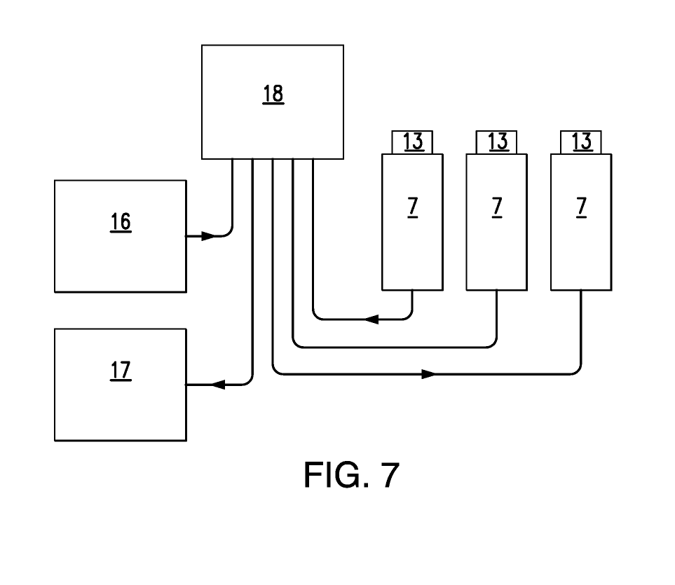

An electric power generation plant comprising a fleet of, for example three, battery/solar powered TRUs equipped with batteries (7) solar panels (13), are ganged together in a charging network to form a local dc micro-grid as illustrated in FIG. 7. When the solar powered TRUs are parked in the warehouse yard for loading or staging, they can be plugged into the micro-grid. This fleet of TRUs becomes a local solar power generation plant where individual TRUs that need battery charging get power from not only their own solar panel (13) but also the solar panel from all other TRUs that have fully charged batteries and a separate land based auxiliary solar panel (16).

Charging of each TRU battery (7) from the central storage battery (17) and from each fully charged TRU's solar panel (13) and the auxiliary solar panel (16), is managed by a central charge control unit (18). Electric power from the ac power company grid, known as shore power, is no longer required and the fleet of TRUs can operate solely on solar power.

The airflow ducts (4) can be recessed into the ceiling of the refrigeration chambers. They become rectangular shaped ducts (19) as shown in FIG. 5. The rectangular duct (19) fits into TRU semi-trailers without modifying standard insulated ceilings.

Expanded silicon dioxide beads (20) fill the box containing a battery assembly (7) shown in FIG. 1. These beads act as a fire retardant if a high thermal event occurs in the battery (7). The sides of the battery box can be manufactured from expanded silicon dioxide aggregate panels (21) for fire protection.

What is claimed is:

1. A high efficiency battery powered transport refrigeration unit with zone isolation comprising:
A. a refrigeration system wherein timer controls are used to limit refrigerant flow from a freezer zone to remote evaporators, said remote evaporators being located in refrigeration zones;
B. a refrigeration air handling system wherein air is extracted directly from a post evaporator cold-air chamber of said host freezer zone, said extracted air being distributed to each said refrigeration zone to control a single zone temperature, or multiple temperatures in multiple zones, by airflow control using a combination of fans, ducts, gates and air temperature controllers.

2. The high efficiency battery powered TRU with zone isolation as claimed in claim 1 wherein, in addition, there is a battery that powers said TRU refrigeration system that consumes less than 18 Kwh of electrical energy.

3. A high efficiency battery powered TRU as claimed in claim 2 wherein, in addition, said zone isolation consists of a knock sensor detector (not in the drawings, or numbered) for liquid refrigerant returning to a compressor that:
i. switches on a return line heater keeping the returning refrigerant in gas phase, and
ii. alternatively shuts off said refrigeration system.

4. A high efficiency battery powered TRU as claimed in claim 2 that, in addition, includes a sensor (not in drawings) that detects a refrigerator door open condition (not in the drawings) and sends a signal to said zone isolation controller (not in the drawings) to completely shut down said refrigerator or reduce its cooling duty cycle.

5. A high efficiency battery powered TRU as claimed in claim 2 wherein, in addition, there is a compressor driven by a motor selected from the group consisting of:
i. a direct current brushed motor;
ii. direct current brushless motor,
iii. an induction alternative current motor with a direct current to alternate current converter.

6. A high efficiency battery powered TRU as claimed in claim 5 wherein the motor is a separate component from the compressor or integral with the compressor.

7. A high efficiency battery powered TRU as claimed in claim 1 wherein, in addition, wherein said refrigeration air handling system is conducted wherein return air is directed through one side of said evaporator and then its direction is reversed to make said air pass through an opposite side of said evaporator.

8. A high efficiency battery powered TRU as claimed in claim 1 wherein there is, in addition, a thermoelectric device used as a sub-cooler to add capacity to a condenser and separately used to provide cooling for said temperature sensors.

9. A high efficiency battery powered TRU as claimed in claim 2 wherein a solar panel is used to charge said battery and run said TRU refrigeration system.

10. A high efficiency battery powered TRU as claimed in claim 1 wherein said solar panel is the only power generation source and said power generated is sufficient to supply all the power necessary to run said refrigeration unit.

11. A high efficiency battery powered TRU as claimed in claim 1 wherein there is, in addition, a backup wheel generator system that only makes power during deceleration.

12. A high efficiency battery powered TRU as claimed in claim 11 wherein said high efficiency battery powered TRU is programed to continuously produce power during emergency low-battery voltage situations.

13. An electric power generation plant comprising a fleet of high efficiency battery powered TRUs as claimed in claim 1 that are equipped with solar panels, ganged together in a charging network.

14. A high efficiency battery powered TRU as claimed in claim 1 wherein airflow ducts are recessed into the ceiling of said refrigeration chamber.

15. A high efficiency battery powered TRU as claimed in claim 1 wherein cold plates composed of eutectic solutions or phase change materials are used to cool refrigeration chambers and battery assemblies.

16. A high efficiency battery powered TRU as claimed in claim 1 wherein a box containing a battery assembly is filled with expanded glass beads.

17. A high efficiency battery powered TRU as claimed in claim 1 wherein a box containing a battery assembly is manufactured from expanded glass aggregate panels.
